(19) United States
(12) Patent Application Publication
(10) Pub. No.: US 2009/0003609 A1
(43) Pub. Date: Jan. 1, 2009

(54) Method for Updating Encryption Keystores Within a Data Processing System

(76) Inventors: Shannon H. Chang, Vail, AZ (US); Khanh V. Ngo, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/771,060

(22) Filed: Jun. 29, 2007

(51) Int. Cl. H04L 9/00

(52) U.S. Cl. 380/286

(57) ABSTRACT

A method for updating encryption keystores within a computer network having multiple host computers is disclosed. A keystore is initially loaded into a key manager within one of the host computers. In response to a key request by a peripheral device within the computer network, a determination is made whether or not the keystore is currently being updated. In a determination that the keystore is not currently being updated, the loaded keystore is utilized to handle the key request. In a determination that the keystore is currently being updated, any incoming key request is redirected to a local queue associated with the key manager. Afterwards, the updated keystore is utilized to handle the key request and any other key request pending in the local queue associated with the key manager.

### BACKGROUND OF THE INVENTION

1. Technical Field

The present invention relates to data processing systems in general, and more particularly, to data processing systems utilizing encryption keys. Still more particularly, the present invention relates to a method for updating encryption keystores within a data processing system.

2. Description of Related Art

In general, conventional encryption systems utilize multiple encryption keys with each encryption key being unique and unpredictable. For example, an Advanced Encryption Standard (AES) encryption key is typically a random string of bits generated for scrambling and unscrambling data. The longer an encryption key string, the more difficult it is for a hacker to break the code that is encrypted by the encryption key.

For applications and/or environments that are not capable of performing key management, an Encryption Key Manager (EKM), such as an EKM component for the Java™ platform manufactured by International Business Machines of Armonk, N.Y., is utilized to perform all necessary key management tasks. Some key management tasks include issuing requests for encryption keys and maintaining an updated keystore of known encryption keys. Thus, an EKM can be utilized to work with encryption-enabled tape drives to generate, protect, store, and maintain encryption keys for encrypting and decrypting information being written to and from tape media. Ideally, an EKM should be constantly accessible by multiple peripheral devices that require encryption keys. However, conventional methods of updating a keystore require that an EKM be manually taken offline during the performance of encryption keystone updates.

Consequently, it would be desirable to provide an improved method for updating encryption keystores within a data processing system.

### SUMMARY OF THE INVENTION

In accordance with a preferred embodiment of the present invention, a computer network includes multiple host computers. A keystore is initially loaded into a key manager within one of the host computers. In response to a key request by a peripheral device within the computer network, a determination is made whether or not the keystore is currently being updated. In a determination that the keystore is not currently being updated, the loaded keystore is utilized to handle the key request. In a determination that the keystore is currently being updated, any incoming key request is redirected to a local queue associated with the key manager. Afterwards, the updated keystore is utilized to handle the key request and any other key request pending in the local queue associated with the key manager.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer network having multiple host computers, in accordance with a preferred embodiment of the present invention; and

FIG. 2 is a high-level logic flow diagram of a method for updating a keystore within one of the host computers from FIG. 1, in accordance with a preferred embodiment of the invention.

### DETAILED DESCRIPTION OF A PREFERRED EMBODIMENT

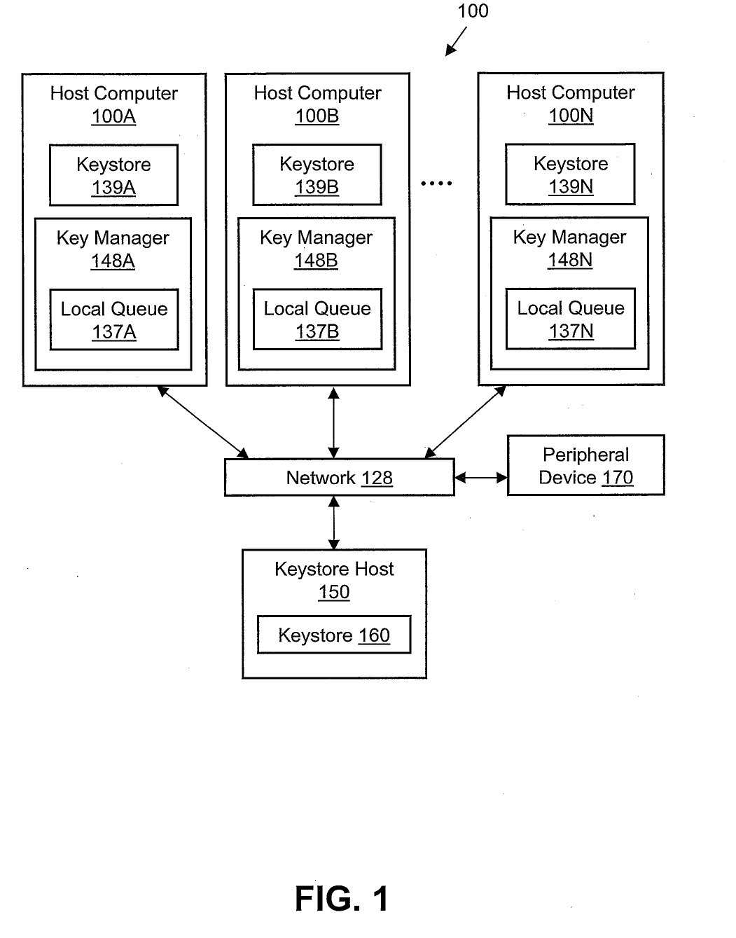

With reference now to the drawings, and in particular to FIG. 1, there is illustrated a block diagram of a computer network having multiple host computers, in accordance with a preferred embodiment of the present invention. As shown, a computer network 100 includes multiple host computers 100A-100N connected to a network connection 128 that is coupled to a peripheral drive 170 such as a tape drive. In addition, network connection 128 is also coupled to a keystore host 150 having a keystore 160.

Each of host computers 100A-100N includes a respective keystore controlled by a key manager having a local queue. For example, host computer 100A includes a keystore 139A and a key manager 148A having a local queue 137A, host computer 100B includes a keystore 139B and a key manager 148B having a local queue 137B, and host computer 100N includes a keystore 139N and a key manager 148N having a local queue 137N. Although a keystore is shown to be located within the same host computer as its key manager, the keystore may be located within a different host computer from that of its key manager.

As utilized herein, a key manager refers to a utility, such as an Encryption Key Manager (EKM), for maintaining multiple encryption keys within a keystore. For example, key manager 148A reads one or more encryption keys from keystore 139A in response to a key request from peripheral device 170. The local queue within each key manager is utilized to temporarily store one or more key requests during keystore updates by its key manager. Thus, local queue 137A allows key manager 148A to update keystore 139A without rejecting any key request from peripheral device 170 during the keystore update process. Although an encryption key corresponding to a key request is described to be located in a keystore within the same host computer as the key manager, the encryption key corresponding to the key request may be located in a keystore within a different host computer.

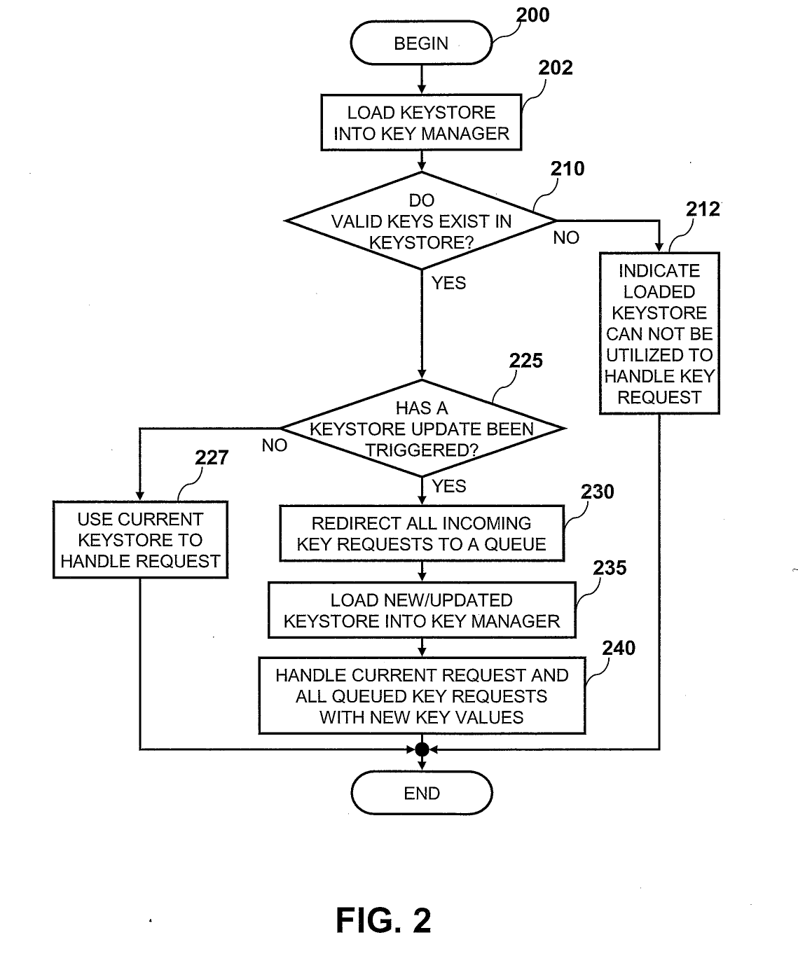

With reference now to FIG. 2, there is illustrated a high-level logic flow diagram of a method for updating keystores within one of host computers 100A-100N from FIG. 1, in accordance with a preferred embodiment of the invention. Starting at block 200, a keystore is initially loaded into a key manager, such as key manager 148A from FIG. 1, as shown in block 202. In response to the receipt of a key request from a peripheral device, such as peripheral device 170 from FIG. 1, the key manager determines whether or not a valid encryption key corresponding to the key request exists in the loaded keystore, as depicted in block 210. If a valid encryption key does not exist in the loaded keystore, the key manager indicates that the keystore cannot be utilized to handle the key request, as depicted in block 212, and the process terminates.

If a valid encryption key exists in the loaded keystore, the key manager determines whether or not the keystore is currently being updated, as depicted in block 225. There are at least three methods for initiating a keystore update. With the first method, the key manager detects a newer timestamp on a keystore, and if the keystore having a newer timestamp is found, the key manager will discard the previous copy of the keystore and loads the keystore having a newer timestamp. With the second method, the key manager compares the contents of the keystores in the computer network with its current keystore. As the third method, a user can initiate a keystore update.

If the keystore is not currently being updated, the current keystore (obtained in block 202) is utilized to handle the pending key request (from block 210), as shown in block 227. Otherwise, if the keystore is currently being updated, the key manager redirects all incoming key request to its local queue, such as local queue 137A for key manager 148A from FIG. 1, as shown in block 230, while loading the more current keystore (i.e., the encryption key updates) into its keystore, as depicted in block 235. The key manager subsequently handles the pending key request (from block 210) as well as the key requests stored in the local queue (from block 230) using the more current keystore, as shown in block 240.

In the flow diagram of FIG. 2 above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As has been described, the present invention provides an improved method for updating encryption keystores within a host computer.

While an illustrative embodiment of the present invention has been described in the context of a fully functional computer system, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method for updating encryption keystores within a network of host computers, said method comprising:
loading a keystore into a key manager within one of said host computers;
in response to a key request by a peripheral device within said network, determining whether or not said keystore is currently being updated;
in a determination that said keystore is not currently being updated, utilizing said keystore to handle said key request; and
in a determination that said keystore is currently being updated,
redirecting any incoming key request to a local queue associated with said key manager; and
subsequently utilizing said updated keystore to handle said key request from said peripheral device and any other key request pending in said local queue associated with said key manager.

2. The method of claim 1, wherein said method further includes determining whether or not a valid key for said key request exists within said loaded keystore.

3. The method of claim 2, wherein said method further includes in a determination that a valid key for said key request does not exist within said loaded keystore, indicating said keystore cannot be utilized to handle said key request.

4. A computer storage medium having a computer program product for updating encryption keystores within a network of host computers, said computer storage medium comprising:
computer program code for loading a keystore into a key manager within one of said host computers;
computer program code for, in response to a key request by a peripheral device within said network, determining whether or not said keystore is currently being updated;
computer program code for, in a determination that said keystore is not currently being updated, utilizing said keystore to handle said key request; and
computer program code for, in a determination that said keystore is currently being updated,
redirecting any incoming key request to a local queue associated with said key manager; and
subsequently utilizing said updated keystore to handle said key request from said peripheral device and any other key request pending in said local queue associated with said key manager.

5. The computer storage medium of claim 4, wherein said computer storage medium further includes computer program code for determining whether or not a valid key for said key request exists within said loaded keystore.

6. The computer storage medium of claim 5, wherein said computer storage medium further includes computer program code for, in a determination that a valid key for said key request does not exist within said loaded keystore, indicating said keystore cannot be utilized to handle said key request.
